(19) United States
(12) Patent Application Publication
(10) Pub. No.: US 2014/0140533 A1
(43) Pub. Date: May 22, 2014

(54) Electronic Device Having Components With Elastomeric Sealing Structures

(71) Applicant: APPLE INC., Cupertino, CA (US)

(72) Inventors: Shayan Malek, San Jose, CA (US); Michael B. Wittenberg, Sunnyvale, CA (US); Warren Z. Jones, San Jose, CA (US)

(73) Assignee: Apple Inc., Cupertino, CA (US)

(21) Appl. No.: 13/682,609

(22) Filed: Nov. 20, 2012

(51) Int. Cl. H04R 1/02; H04R 1/10; H04R 31/00; H04R 1/08

(52) U.S. Cl. CPC H04R 1/02; H04R 1/083; H04R 1/1091; H04R 31/006
USPC 381/91; 381/87; 381/395; 29/527.1; 264/259

(57) ABSTRACT

An electronic device has a housing in which components are installed. The components contain audio components having audio ports and terminals. Elastomeric material is molded over the surface of an audio component so that the leads attached to the terminals protrude through the elastomeric material. The protruding portions of the leads are bent back to lie flush with the surface of the elastomeric material. The elastomeric material are configured to form elastomeric structures with an opening that is aligned with the audio port in a component. The housing of an electronic device has one or more openings that form an audio port. The opening in the elastomeric structures that are molded onto the audio component is aligned with the audio port in the housing and the audio port in the audio component. Mesh structures cover the audio port in the housing.

### BACKGROUND

This relates generally to electronic devices and, more particularly, mounting components in electronic devices.

Electronic devices include electrical components. Some electrical components such as integrated circuits can be mounted on printed circuit boards. Other electrical components such as audio components are typically mounted adjacent to housing openings. With this type of mounting arrangement, ambient sounds can be picked up by a microphone and sounds produced by a speaker can be heard by a user of the device.

Modern audio components are sometimes attached to printed circuits. For example, one conventional microphone mounting approach involves attaching a flexible printed circuit with a microphone to a device housing adhesive and foam. The flexible printed circuit in this type of configuration may have an opening for the microphone that is aligned with a housing opening. A silicone boot is mounted over the microphone so that the edges of the boot form a seal with the housing. Another conventional microphone mounting approach uses a silicone boot with an opening that passes between an opening in the flexible printed circuit on which the microphone is mounted and an opening in a housing. Adhesive and foam are used to attach the flexible printed circuit and microphone to the silicone boot in alignment with the opening in the silicone boot.

Conventional audio component mounting structures such as these can be difficult to align properly during assembly. The foam and the silicone material in the microphone boot structure can deform during assembly, making alignment and accurate assembly challenging. If care is not taken, pieces of the mounting structures may be misaligned with respect to each other, potentially leading to improper seal formation around a boot and leaks of moisture or other contaminants into interior portions of a device housing.

It would therefore be desirable to be able to form electronic devices with improved electronic component mounting structures.

### SUMMARY

An electronic device has a housing in which components are installed. The components may contain audio components such as microphones and speakers that have audio ports and signal terminals.

The audio components may include metal leads that are attached to the terminals. Elastomeric material may be molded over the surface of an audio component so that the leads protrude. The protruding portions of the leads may be bent back to lie flush with the surface of the elastomeric material. Signal lines such as metal traces in a flexible printed circuit may be coupled to the leads.

The elastomeric material may be configured to form elastomeric structures that have an opening that is aligned with the audio port in a component. The housing may of an electronic device may have one or more openings that form an audio port. The opening in the elastomeric structures that are molded onto the audio component may be aligned with the audio port in the housing and the audio port in the audio component. Mesh structures may cover the audio port in the housing.

Further features, their nature and various advantages will be more apparent from the accompanying drawings and the following detailed description of the preferred embodiments.

### BRIEF DESCRIPTION OF THE DRAWINGS

FIG. 1 is a perspective view of an illustrative electronic device of the type that may be provided with audio components having integral elastomeric boot structures in accordance with an embodiment.

FIG. 2 is a schematic view of an illustrative electronic device of the type that may be provided with audio components having integral elastomeric boot structures in accordance with an embodiment.

FIG. 3 is a diagram showing equipment that may be used in forming an electrical component such as an audio component with an integral elastomeric boot and that may be used in incorporating the audio component into an assembled electronic device in accordance with an embodiment.

FIG. 4 is a cross-sectional side view of a component such as an audio component that has been provided with an integral elastomeric boot that covers part of the audio component in accordance with an embodiment.

FIG. 5 is an exploded perspective view of component mounting structures including a component such as an audio component that has been provided with an integral elastomeric boot in accordance with an embodiment.

FIG. 6 is an interior perspective view of electrical component mounting structures being used to mount an electrical component such as an audio component with an integral elastomeric boot to an electronic device housing sidewall in an electronic device in accordance with an embodiment.

FIG. 7 is an exterior perspective view of electrical component mounting structures being used to mount an electrical component such as an audio component with an integral elastomeric boot to a sidewall in an electronic device housing in an electronic device in accordance with an embodiment.

FIG. 8 is a flow chart of illustrative steps involved in forming a component such as an audio component with an integral boot and involved in mounting the component within an electronic device in accordance with an embodiment.

### DETAILED DESCRIPTION

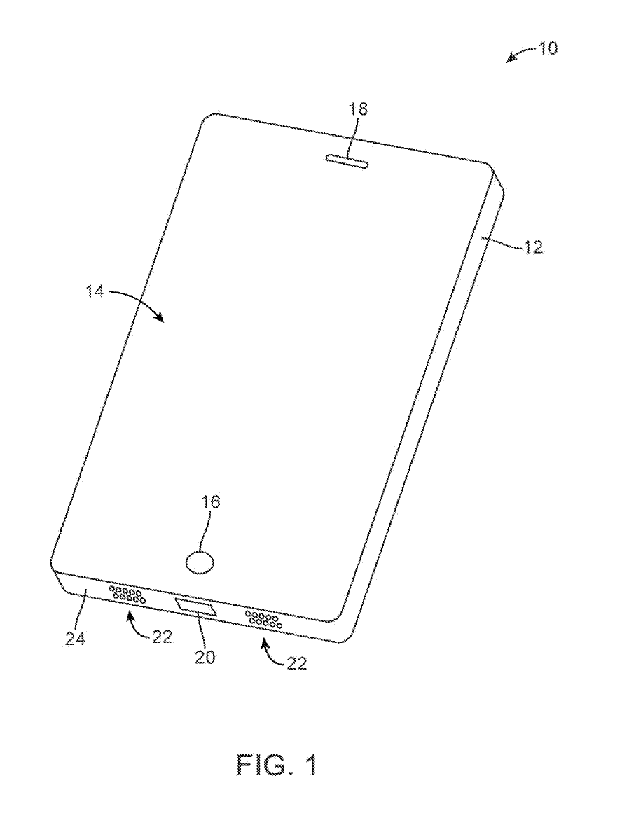

An illustrative electronic device that may be provided with electrical components such as audio components and component mounting structures such as integral elastomeric boot structures is shown in FIG. 1. Electronic devices such as device 10 of FIG. 1 may be cellular telephones, media players, other handheld portable devices, somewhat smaller portable devices such as wrist-watch devices, pendant devices, or other wearable or miniature devices, gaming equipment, tablet computers, notebook computers, desktop computers, televisions, computer monitors, computers integrated into computer displays, or other electronic equipment.

In the example of FIG. 1, device 10 includes a display such as display 14. Display 14 has been mounted in a housing such as housing 12. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.).

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures.

Display 14 may include an array of display pixels formed from liquid crystal display (LCD) components, an array of electrophoretic display pixels, an array of plasma display pixels, an array of organic light-emitting diode display pixels, an array of electrowetting display pixels, or display pixels based on other display technologies.

Display 14 may be protected using a display cover layer such as a layer of transparent glass or clear plastic. Openings may be formed in the display cover layer. For example, an opening may be formed in the display cover layer to accommodate a button such as button 16. An opening may also be formed in the display cover layer to accommodate ports such as ear speaker port 18. Openings may be formed in housing 12 to accommodate buttons and other devices. As shown in FIG. 1, openings may be formed in housing structures such as housing wall 24 of housing 12 to accommodate connector 20 and to form audio ports 22.

Audio ports 22 may be used to allow sound from the exterior of device 10 such as a user's voice to pass to a microphone in the interior of device 10. Audio ports 22 may also be used to allow sound from a speaker in the interior of device 10 to pass to the exterior of device 10 (e.g., so that the sound may be heard by a user of device 10). In the illustrative configuration of FIG. 1, lower housing wall 24 of housing 12 has been provided with two audio ports 22, one of which is being used as a microphone port and one of which is being used as a speaker port. Configurations in which more than two audio ports or fewer than two audio ports are included in device 10 and in which audio ports are located in different portions of housing 12 may be used, if desired.

Audio ports 22 of FIG. 1 are formed from clusters of circular openings (e.g., a set of ten circular openings per port). Other sizes and shapes of openings may be used in forming each audio port. For example, a group of non-circular openings or a mixture of circular and non-circular openings can be used, ports can be formed from a single opening, or ports can be formed from slots. If desired, metal mesh or plastic mesh may be used in covering some or all of a port or other port structures may be formed in device 10.

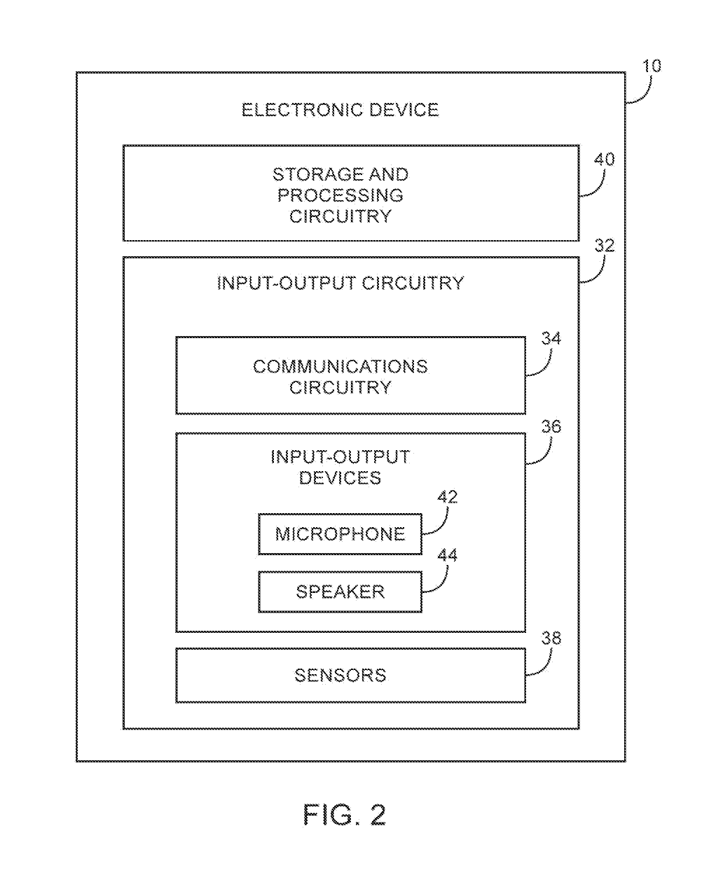

A schematic diagram of device 10 is shown in FIG. 2. As shown in FIG. 2, electronic device 10 may include control circuitry such as storage and processing circuitry 40. Storage and processing circuitry 40 may include one or more different types of storage such as hard disk drive storage, nonvolatile memory (e.g., flash memory or other electrically-programmable-read-only memory), volatile memory (e.g., static or dynamic random-access-memory), etc. Processing circuitry in storage and processing circuitry 40 may be used in controlling the operation of device 10. The processing circuitry may be based on a processor such as a microprocessor and other suitable integrated circuits. With one suitable arrangement, storage and processing circuitry 40 may be used to run software on device 10 such as internet browsing applications, email applications, media playback applications, software for playing audio with speakers and capturing audio signals using microphones, operating system functions, software for capturing and processing images, software implementing functions associated with gathering and processing sensor data, software that makes adjustments to display brightness and touch sensor functionality, etc.

Input-output circuitry 32 may be used to allow input to be supplied to device 10 from a user or external devices and to allow output to be provided from device 10 to the user or external devices.

Input-output circuitry 32 may include wired and wireless communications circuitry 34. Communications circuitry 34 may include radio-frequency (RF) transceiver circuitry formed from one or more integrated circuits, power amplifier circuitry, low-noise input amplifiers, passive RF components, one or more antennas, and other circuitry for handling RF wireless signals. Wireless signals can also be sent using light (e.g., using infrared communications).

Input-output circuitry 32 may include input-output devices 36 such as button 16 of FIG. 1, joysticks, click wheels, scrolling wheels, a touch screen such as display 14 of FIG. 1, other touch sensors such as track pads or touch-sensor-based buttons, vibrators, one or more audio components such as one or more microphones such as microphone 42 and one or more speakers such as speaker 44, image capture devices such as a camera module having an image sensor and a corresponding lens system, keyboards, status-indicator lights, tone generators, key pads, and other equipment for gathering input from a user or other external source and/or generating output for a user.

Sensor circuitry such as sensors 38 of FIG. 2 may include an ambient light sensor for gathering information on ambient light levels, proximity sensor components (e.g., light-based proximity sensors and/or proximity sensors based on other structures), accelerometers, gyroscopes, magnetic sensors, and other sensor structures.

Audio components such as microphone 42 and speaker 44 are used to receive and transmit sound. Audio components are therefore generally mounted near to an opening in housing 12 such as one of audio ports 22 of FIG. 1. In this type of location, there is a potential for moisture, dust, or other environmental contaminants to enter the interior of device 10. If environmental contaminants enter device housing 12, audio components and other components in device 10 may be damaged. To prevent environmental contaminants from entering device 10, environmental seals may be formed around audio components. Adhesive, elastomeric materials such as silicone, gasket structures, and other sealing structures may be used in forming environmental seals in device 10.

With one suitable arrangement, which is sometimes described herein as an example, a polymer such as silicone or other elastomeric material is molded over some or all of an audio component to form an audio component with an integral elastomeric sealing structure. The integral elastomeric sealing structure, which may sometimes be referred to as a boot, elastomeric structure, or elastomeric boot structure, may be pressed against the inside of a housing wall (i.e., an interior portion of housing 12 next to one of ports 22) or may contact other structures in device 10 in the vicinity of port 22 so that an environmental seal is formed between the elastomeric sealing structure and the housing wall or other structure. The seal may prevent environmental contaminants from entering the interior of housing 12.

It can be challenging to align component mounting structures that move with respect to each other, so forming an integral elastomeric boot structure on an audio component may help overcome alignment challenges that might arise when using a separate boot. Sealing structures can be formed from thermoset polymers (e.g., a thermoset elastomer such as acrylonitrile butadiene), from thermoplastic polymers (e.g., silicone or thermoplastic polyurethane), or from a combination of two or more polymers (e.g., using a multi-shot injection molding process).

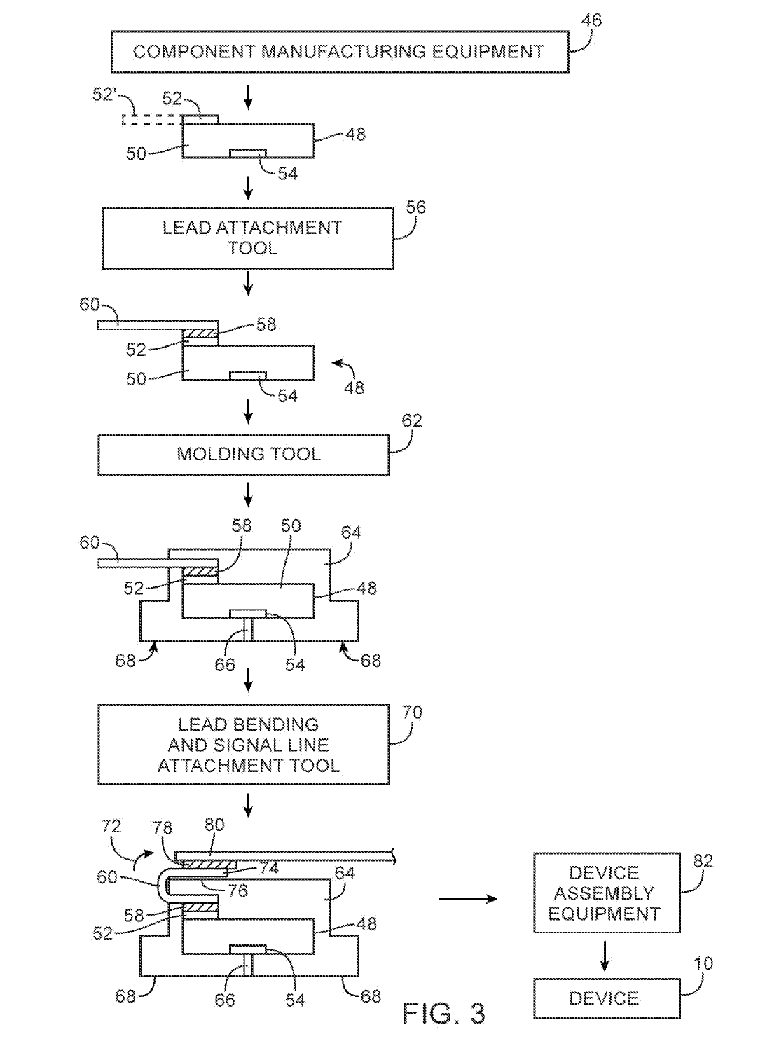

Injection molding techniques (sometimes referred to as insert molding techniques) or other suitable manufacturing techniques may be used in forming integral polymer boot structures on electronic components such as audio components. Illustrative molding equipment and techniques for forming integral elastomeric boot structures and in installing audio components with integral elastomeric boot structures in an electronic device are shown in FIG. 3.

In the illustrative example of FIG. 3, component manufacturing equipment 46 is used to produce component 48. Component 48 may be, for example, an audio component such as a microphone or speaker. Component 48 may have a body such as body 50 that is formed from plastic, metal, ceramic, glass, other materials, or combinations of these materials. Body 50 may, for example, include polycarbonate or other polymer materials (e.g., rigid plastics). Metal structures such as terminal structures 52 may be formed on body 50. For example, in an audio component such as a microphone, terminals may be provided to supply microphone signals to external equipment. In an audio component such as a speaker, terminals may be provided that allow external audio output circuitry to drive audio signals into the speaker.

There may be any suitable number of terminals 52 on body 50 (e.g., two or more). Terminal structures 52 may, for example, include flat metal pads or other contacts that are suitable for forming solder connections or for forming connections using other types of connection structures (e.g., welds, screws, conductive adhesive, other conductive materials, etc.).

Component 48 may include one or more openings, windows, recesses, protrusions, or other structural features. In the example of FIG. 3, component 48 has a port such as port 54. Port 54 may include one or more openings that serve as an audio port to allow sound to pass between the interior and exterior of component 48. In configurations in which component 48 is a microphone, for example, port 54 may be a microphone port that allows sound from the exterior of microphone 48 to be received by a microelectromechanical systems (MEMS) microphone structure or other internal microphone structure (e.g., a diaphragm formed from polymer and/or metal) that is mounted in an interior cavity portion of body 50. In configurations in which component 48 is a speaker, port 54 may be a speaker port. The interior of body 50 in this type of arrangement may form a speaker cavity that contains a speaker driver. Port 54 may have one or more openings that allow sound that is produced by the internal speaker driver to exit component 48.

To facilitate attachment of signal lines to component 48 (e.g., to facilitate attachment of wires, flexible printed circuit conductors or other conductive paths to component 48), it may be desirable to form extended portions on terminal structures 52. For example, terminal structures 52 may be implemented using pieces of metal that extend outwardly from body 50 and form protruding leads, as indicated by dashed line 52′ of FIG. 3. As another example, strips of metal or other metal structures may be attached to structures 52 to form leads using equipment such as lead attachment tool 56. In the illustrative configuration of FIG. 13, lead attachment tool 56 includes soldering equipment (e.g., a hot bar soldering tool, a reflow oven, etc.) that solders leads such as lead 60 to terminal structure 52 using solder 58. If desired, lead structures such as structure 60 of FIG. 3 may be attached to component 48 using fasteners, welds, conductive adhesive, or other conductive coupling mechanisms.

Following formation of protruding conductive terminal structures such as terminal leads 60 or other conductive terminal structures for conveying signals to and from component 48, equipment such as molding tool 62 can be used to form an integral polymer structure on component 48 such as structure 64. Equipment 62 may include equipment for injection molding plastic, for applying a polymer coating using spraying or dripping techniques, equipment for painting polymer using a pad or brush, equipment for molding, casting, or otherwise applying a thermoset polymer to component 48, or other suitable equipment for forming integral polymer structures on component 48.

With one suitable arrangement, which is sometimes described herein as an example, equipment 62 is an injection molding tool that is used to injection mold plastic 64 (e.g., thermoplastic material such as an elastomeric thermoplastic) onto component 48 while applying heat and pressure. The molding process helps form physical and chemical bonds that seal overmolded plastic material 64 to the structures of component 48 such as terminals 60 and component body 50. This can help prevent moisture intrusion and the intrusion of other environmental contaminants into the interfaces between component 48 and plastic 64.

As shown in FIG. 3, plastic 64 can be formed into the shape of an elastomeric boot structure that encloses some or all of component 48. Covering component 48 with structures 64 in this way provides component 48 with environmental sealing and creates a boot structure that itself can be pressed against housing wall structures in housing 12 or other portions of device 10 to form environmental seals. As an example, portions 68 of integral elastomeric boot structure 64 can be pressed against the inner surface of housing 12 or associated structures surrounding a port such as one of ports 22 of FIG. 1, thereby forming an audio port seal for component 48.

Elastomeric boot structure 64 can be provided with one or more openings such as port 66. Port may be formed form one or more openings in elastomeric boot structure 64 (e.g., one or more cylindrical holes or openings of other suitable shapes). As shown in FIG. 3, port opening 66 is preferably aligned with port 54 in component 48. In configurations in which component 48 is an audio component such as a microphone, the alignment between opening 66 of elastomeric boot structure 64 and port 54 of microphone 48 will allow sound from the exterior of component 48 to pass through opening 66 and port 54 into internal structures of component 48 that convert the received sound into electrical signals on terminals 60. In configurations in which component 48 is an audio component such as a speaker, the alignment between opening 66 of elastomeric boot structure 64 and port 54 of speaker 48 will allow sound from a speaker driver in a speaker box cavity in the interior of speaker body 50 to exit through port 54 and opening 66. When component 48 is mounted in device 10 so that portions of elastomeric boot structures 64 such as portions 68 form seals with housing 12 or other device structures such as structures attached to housing 12, opening 66 of elastomeric boot structure 64 is preferably aligned with audio port openings 22 in housing 12.

In configurations for component 48 in which metal terminal structures such as leads 60 extend outwardly from elastomeric boot 64 following the molding of elastomeric boot 64 onto component body 50, it may be desirable to bend, twist, or otherwise manipulate leads 60. In the illustrative example of FIG. 3, equipment 70 includes lead bending equipment that bends tip portions 74 of leads 60 around the outer surface of elastomeric boot structure 64 in direction 72. Leads 60 may be placed, for example, in a configuration in which tips 74 of leads 60 rest on rear (inner) surface 76 of elastomeric boot structure 64, so that leads 60 lie flush with the rear surface of elastomeric boot structure 64.

Equipment 70 of FIG. 3 also includes signal line attachment equipment that attaches signal lines 80 to leads 60 using conductive material 78. Signal lines 80 may be formed from wires, strips of metal, patterned metal foil, or other patterned metal members, metal traces on molded plastic substrates or other dielectric members, or printed circuit traces. As an example, signal lines 80 may be formed from metal traces on a printed circuit such as a rigid printed circuit board formed from a material such as fiberglass-filled epoxy or a flexible printed circuit formed from a sheet of polyimide or other flexible layer of polymer.

Conductive material 78 may be conductive adhesive such as anisotropic conductive film, solder, metal associated with a weld or fastener-based connection, or other conductive material. Tool 70 may include lead bending equipment for bending lead 60 in direction 72 to lie flat on rear surface 76 of boot 64 and/or soldering equipment such as a hot bar tool, reflow oven, or other equipment for using conductive material 78 to attach signal lines 80 to leads 60. If desired, signal lines 80 may include conductive contact pads (e.g., metal traces patterned to form rectangular metal pads) that are coupled to leads 60 by pressing the contact pads against leads 60 using a bracket, foam, or other biasing structure without placing intervening conductive material 78 between leads 60 and the metal pads.

Device assembly equipment 82 includes manually controlled assembly tools and computer-controlled positioners that assemble device structures to form device 10. Assembly equipment 82 preferably is used in installing component 48 and integral elastomeric boot 64 within device housing 12 so that portions 68 of integral elastomeric boot 64 or other portions of elastomeric boot 64 form environmental seals (e.g., seals around audio ports 22). Signal lines 80 may be attached to leads 60 before elastomeric boot 64 is assembled into device 10 to form seals around port 22 or may be attached to leads 60 during assembly operations or after elastomeric boot 64 has been assembled into device 10 to form an environmental seal.

During assembly operations with device assembly equipment 82, opening 66 in elastomeric boot 64 is preferably aligned with openings in port 22. Opening 66 was also aligned with port 54 in component 48 during the process of forming integral elastomeric boot structure 64. The alignment between opening 66 and port 54 and the alignment between opening 66 and port 22 allows sound to enter and exit component 48 during operation of device 10 by a user (i.e., sound may pass between port 22 and port 54 via opening 66). For example, in a configuration in which component 64 is a microphone, ambient sound from the exterior of device 10 and device housing 12 may be received by a microphone structure in the interior of component body 50 via housing opening 22, elastomeric boot opening 66, and component body opening 54. In a configuration in which component 48 is a speaker, sound that is produced by a speaker driver in the interior of component body 50 will exit speaker 48 through port 54 and will pass to the exterior of device 10 through opening 66 and opening 44.

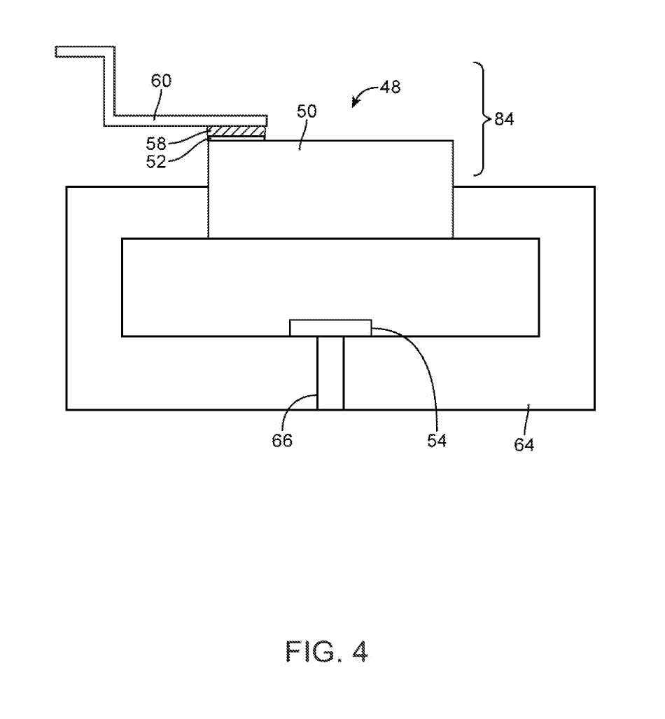

In a configuration of the type shown in FIG. 3, speaker leads 60 protrude through elastomeric boot structure (i.e., leads 60 pass from the interior of boot 64 to the exterior of boot 64). The portions of boot 64 that surround leads 60 help prevent moisture and other environmental contaminants from reaching sensitive portions of component 48 such as solder 58 between terminal structures 52 and leads 60. FIG. 4 shows how elastomeric boot structure 64 may, if desired, be molded onto the lower portion of the exterior of component 48. With this type of arrangement, some of component 48 is covered by elastomeric boot structure 64 and some of component 48 (e.g., exposed portion 84) is exposed and not covered by elastomeric boot structure 64. One or more elastomeric structures such as boot 64 of FIG. 4 may be molded onto component 48, if desired.

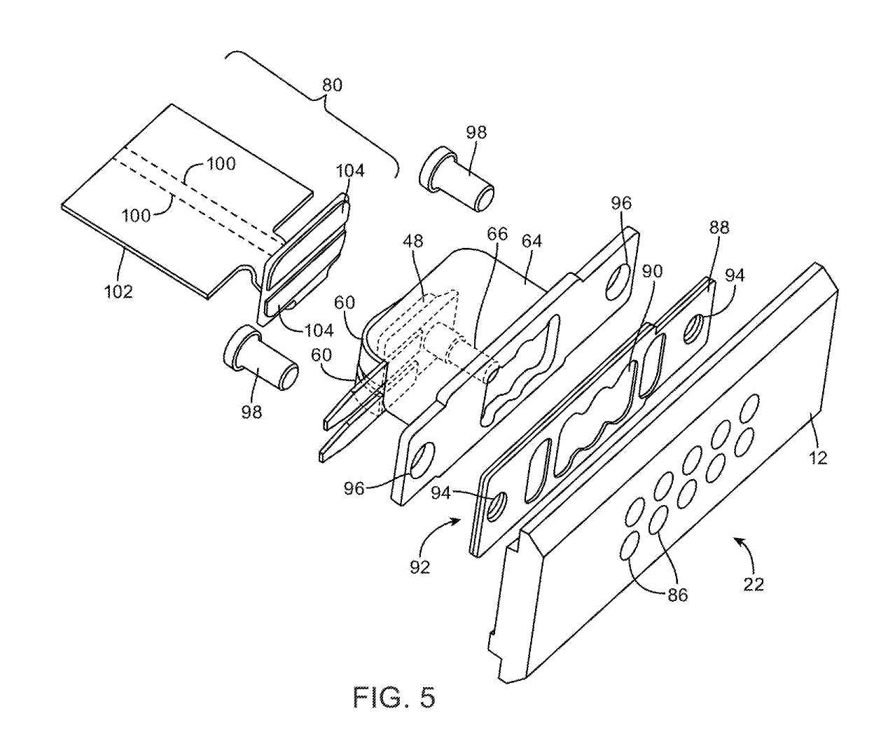

A perspective view of an illustrative component (e.g., audio component 48) and associated mounting structures for mounting component 48 to device housing 12 is shown in FIG. 5. As shown in FIG. 5, housing portion 12 has two rows of circular openings 86 that form audio port 22. Mesh 90 is mounted between opening 66 in elastomeric boot structure 64 and openings 86 to help prevent environmental contaminants from entering opening 66 in elastomeric boot structure 64. Mesh 90 may be formed from one or more layers of metal mesh and/or plastic mesh. If desired, a mounting structure such as mounting structure 88 may be used to attach mesh 90 to housing 12. Mounting structure 88 may have screw holes 94 and elastomeric boot structure 64 may have corresponding aligned screw holes 96. Screws 98 may pass through openings 96 and 94 and may be received within threaded openings in housing 12 to attach elastomeric boot structure 64 and support structure 88 to housing 12.

Signal paths 80 may include a substrate such as flexible printed circuit substrate 102 having one or more metal traces such as metal traces 100. Metal traces 100 may be electrically connected to traces such as contact pads 104. Contact pads 104 may be electrically connected to respective terminal leads 60. During operation, the signal paths formed from leads 60, optional conductive material such as conductive material 78 of FIG. 3, and metal traces that form paths 80 such as contact traces 104 and lines 100 may be used to convey signals to and from electrical component 48.

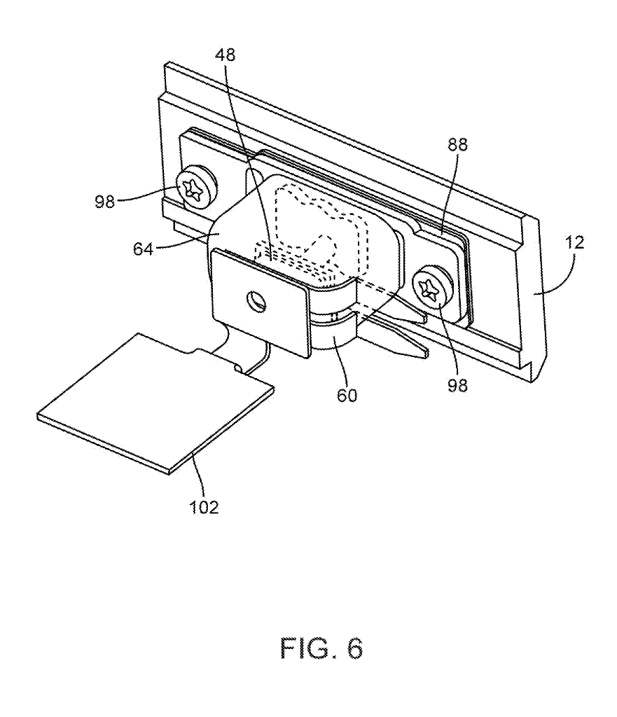

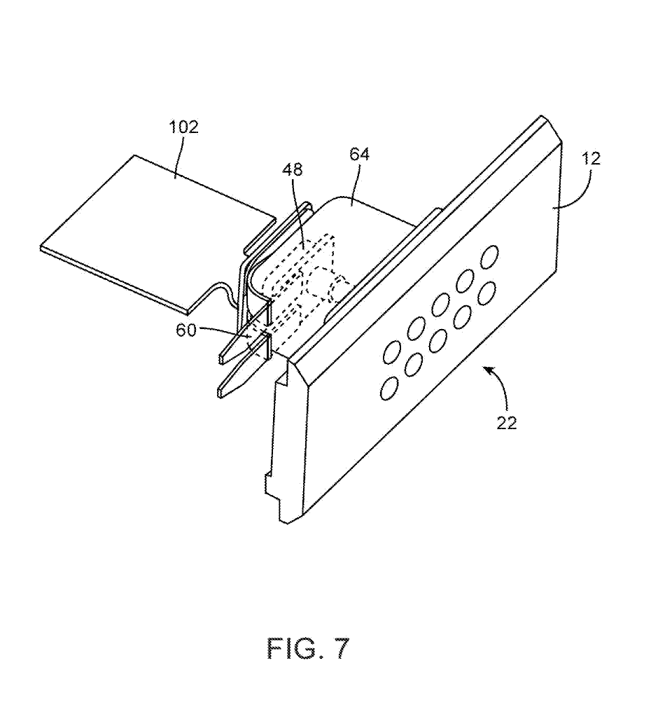

FIG. 6 is an interior perspective view of a portion of housing 12 to which component 48 and integral elastomeric sealing structure 64 have been mounted using screws 98. As shown in FIG. 6, elastomeric boot structure 64 has been secured to housing 12 using screws that pass through opposing edges of elastomeric boot structure 64. Mesh support structure 88 is interposed between elastomeric boot structure 64, so elastomeric boot structure 64 forms an environmental seal by virtue of being pressed up against the inner surface of support structure 88 and by virtue of the seal formed between the opposing outer surface of support structure 88 and the inner surface of housing wall 12. FIG. 7 is a front perspective view of the structures of FIG. 6.

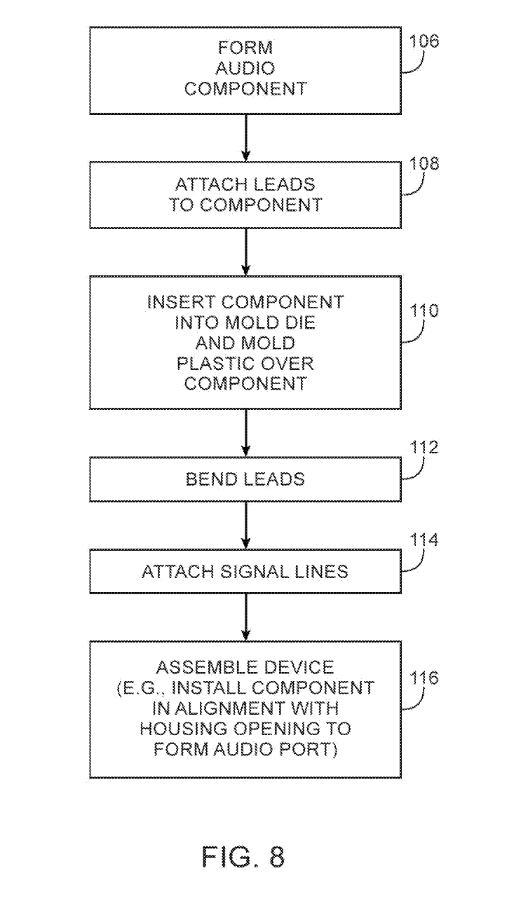

A flow chart of illustrative steps involved in forming electronic components with integral elastomeric sealing structures and involved in assembling such components to form an electronic device is shown in FIG. 8.

At step 106, component manufacturing equipment 46 is used to manufacture an audio component or other component 48. Component 48 may have conductive signal contacts such as terminal structures 52.

At step 108, lead attachment tool 56 may attach conductive structures such as leads 60 to terminal structures 52. For example, lead attachment tool 56 may use solder 58 to solder leads 60 onto terminals 52. If desired, terminals 52 may be formed from elongated metal strips that form leads such as leads 60.

At step 110, molding tool 62 can be used to from integral elastomeric boot structure 64. In particular, component 48 can be placed within the interior of a mold die in molding tool 62. Once placed inside the molding tool, elastomeric polymer material may be injection molded into the tool around component 48. Some or all of component 48 may be covered with integral elastomeric boot structures 64 in this way. The molding process helps form physical and chemical bonds between elastomeric boot structures 64 and component 48 (including leads 60), thereby helping to prevent the intrusion of moisture and other environmental contaminants into internal portions of component 48.

At step 112, leads 60 may be bent to conform to the shape of elastomeric boot structures 64 using equipment 70.

At step 114, equipment 70 may be used to attach signal lines 80 to leads 60 using solder or other conductive material 78 (if desired).

Device assembly equipment 82 may be used to assemble the components of device 10 together during the operations of step 116. For example, component 48 and integral elastomeric boot structure 64 may be installed within housing 12 and signal paths 80 may be electrically coupled to leads 60 in configurations in which leads 60 were not already soldered or otherwise attached to signal lines 80 during step 114. Mesh 90 and mesh support structure 88 or other device structures may be interposed between integral audio component elastomeric sealing structures 64 and housing 12 or structures 64 may be mounted directly against housing 12. In addition to mounting structures 64 within device 10, other structures (e.g., circuitry 40 and 32 of FIG. 2) may be mounted within device housing 12 to form device 10.

The foregoing is merely illustrative and various modifications can be made by those skilled in the art without departing from the scope and spirit of the described embodiments. The foregoing embodiments may be implemented individually or in any combination.

What is claimed is:

1. Apparatus, comprising:
an electrical component having leads; and
an elastomeric structure molded around the leads and molded to the electrical component, wherein the electrical component has a port and wherein the elastomeric structure has an opening that is aligned with the port.

2. The apparatus defined in claim 1 wherein the electrical component comprises an audio component and wherein the port comprises an audio port.

3. The apparatus defined in claim 2 wherein the elastomeric structure covers substantially all of the audio component.

4. The apparatus defined in claim 3 wherein the audio component comprises a microphone and wherein the port comprises a microphone port aligned with the opening in the elastomeric structure.

5. The apparatus defined in claim 4 further comprising a flexible printed circuit having traces that are coupled to the leads.

6. The apparatus defined in claim 4 further comprising an electronic device housing with an opening that is aligned with the opening of the elastomeric structure.

7. The apparatus defined in claim 6 wherein the opening in the electronic device housing comprises one of multiple audio port openings in the electronic device housing that are aligned with the opening in the elastomeric structure.

8. The apparatus defined in claim 7 further comprising a mesh that is interposed between the opening in the elastomeric structure and the multiple audio port openings.

9. The apparatus defined in claim 8 further comprising support structures for the mesh.

10. The apparatus defined in claim 9 wherein the elastomeric structure includes at least one screw hole and wherein the support structures include at least one screw hole aligned with the screw hole in the elastomeric structures.

11. The apparatus defined in claim 1 wherein the leads include a bent portion that is bent to lie on an outer surface of the elastomeric structure.

12. A method of installing audio components in an electronic device, comprising:
molding elastomeric structures to an audio component that cover at least part of the audio component; and
forming an environmental seal with the molded elastomeric structures to prevent intrusion of moisture into an interior portion of the electronic device.

13. The method defined in claim 12 wherein the audio component comprises a microphone with a microphone port and wherein molding the elastomeric structures comprises molding elastomeric material over the microphone to create an opening in the elastomeric structures that is aligned with the microphone port.

14. The method defined in claim 13 wherein the microphone includes terminals, the method further comprising:
attaching leads to the terminals.

15. The method defined in claim 14 wherein molding the elastomeric material comprises molding the elastomeric material around the leads so that tip portions of the leads protrude through the elastomeric structures.

16. The method defined in claim 15 further comprising attaching signal paths in a flexible printed circuit to the leads.

17. The method defined in claim 16 further comprising:
mounting the elastomeric material in alignment with an electronic device housing opening.

18. An electronic device, comprising:
an electronic device housing;
an audio component having terminals; and
elastomeric material molded over the audio component, wherein the elastomeric material forms a seal that blocks environmental contamination.

19. The electronic device defined in claim 18 further comprising leads coupled to the terminals, wherein the leads are configured to protrude through the elastomeric material.

20. The electronic device defined in claim 19 further comprising:
a flexible printed circuit having traces coupled to the leads; and
an opening in the housing, wherein the audio component has an audio port, and wherein the elastomeric material has an opening that is aligned with the audio port of the audio component and the opening in the housing.

21. The electronic device defined in claim 20 wherein the elastomeric material includes at least one screw hole.

22. The electronic device defined in claim 20 wherein the audio component comprises a microphone.

23. The electronic device defined in claim 20 wherein the audio component comprises a speaker.
